(19) United States
(12) Patent Application Publication
(10) Pub. No.: US 2024/0298064 A1
(43) Pub. Date: Sep. 5, 2024

(54) DISPLAY DEVICE AND CONTROL METHOD THEREFOR

(71) Applicant: Samsung Electronics Co., Ltd., Suwon-si (KR)

(72) Inventors: Seokhyun KIM, Suwon-si (KR); Euijun Kim, Suwon-si (KR); Joosun Moon, Suwon-si (KR); Jangwon Seo, Suwon-si (KR); Ahyeon Shim, Suwon-si (KR); Sugyeong Hyeon, Suwon-si (KR)

(73) Assignee: Samsung Electronics Co., Ltd., Suwon-si (KR)

(21) Appl. No.: 18/661,065

(22) Filed: May 10, 2024

Related U.S. Application Data
(63) Continuation of application No. PCT/KR2022/017481, filed on Nov. 8, 2022.

(30) Foreign Application Priority Data
Nov. 10, 2021 (KR) 10-2021-0154294

(51) Int. Cl. H04N 21/431; H04N 21/4363; H04N 21/442; H04N 21/458; H04N 21/482

(52) U.S. Cl. CPC H04N 21/4316; H04N 21/43632; H04N 21/44204; H04N 21/458; H04N 21/4826

(57) ABSTRACT

A display device includes: at least one processor operatively coupled to a memory and configured to execute one or more instructions stored in the memory, in which the one or more instructions cause the display device to: based on reception of a first user input, display, on a display, the broadcasting content received from the external device connected to the display device through an input and output port, and based on reception of a second user input corresponding to a home user interface (UI) button of a remote controller, display a home UI comprising a list of a plurality of pieces of broadcasting content is displayed, and display identification information of the channel stored in the memory.

### CROSS-REFERENCE TO RELATED APPLICATION(S)

This application is a continuation of International Application No. PCT/KR2022/017481, filed on Nov. 8, 2022, which claims priority to Korean Patent Application No. 10-2021-0154294, filed on Nov. 10, 2021, in the Korean Intellectual Property Office, the disclosures of which are incorporated by reference herein their entireties.

### BACKGROUND

### 1. Field

The disclosure relates to a display device and an operating method thereof, and more particularly, to a method of providing broadcasting content and a display device for providing broadcasting content.

### 2. Description of Related Art

Recently, the number of pieces of content reproduced by display devices has increased. For example, not only airwave broadcasting or cable broadcasting, but also the number of over-the-top (OTT) media service applications providing various types of media content through the Internet has increased.

As the number of selectable pieces of content and sources of the pieces of content increase, most display devices provide a separate user interface page for content selection.

However, in order to select a piece of content while content is being viewed, switching to the user interface page has to be additionally performed, and thus, it is not possible to view content while content is being selected. In this regard, the output of the content is terminated to display the user interface page.

### SUMMARY

According to an aspect of the disclosure, a display device includes a display screen; a memory storing one or more instructions; an input and output device configured to connect an external device, the external device providing broadcasting content with the display device; and at least one processor operatively coupled to the memory and configured to execute one or more instructions stored in the memory, in which the one or more instructions, when executed by the at least one processor, cause the display device to: based on reception of a first user input, display, on the display screen, the broadcasting content received from the external device connected to the display device through the input device and the output device, and store, in the memory, identification information of a channel of the broadcasting content and identification information of the external device providing the broadcasting content, and based on reception of a second user input corresponding to a home user interface (UI) button of a remote controller, display a home UI comprising a list of a plurality of pieces of broadcasting content, and display, the identification information of the channel stored in the memory.

According to an aspect of the disclosure, a method, performed by a display device, of providing content includes: based on receiving a first user input, displaying, on a display screen of the display device, broadcasting content received from an external device connected to the display device through an input and an output device of the display device and storing identification information of a channel of the broadcasting content and identification information of the external device providing the broadcasting content; and based on receiving a second user input corresponding to a home user interface (UI) button of a remote controller, display a home UI comprising a list of a plurality of pieces of broadcasting content, and displaying, the stored identification information of the channel.

According to an aspect of the disclosure, a non-transitory computer readable medium having instructions stored therein, which when executed by a processor cause the processor to execute a method comprising: based on receiving a first user input, displaying, on a display screen of the display device, broadcasting content received from an external device connected to the display device through an input and an output device of the display device and storing identification information of a channel of the broadcasting content and identification information of the external device providing the broadcasting content; and based on receiving a second user input corresponding to a home user interface (UI) button of a remote controller, display a home UI comprising a list of a plurality of pieces of broadcasting content, and displaying the identification information of the channel stored in the memory.

According to an aspect of the disclosure, a display device includes: a display; a memory storing one or more instructions; an input and output port configured to connect an external device, the external device providing broadcasting content with the display device; and at least one processor operatively coupled to the memory and configured to execute one or more instructions stored in the memory, in which the one or more instructions, when executed by the at least one processor, cause the display device to: based on reception of a first user input, display, on the display, the broadcasting content received from the external device connected to the display device through the input and output port, and store, in the memory, identification information of a channel of the broadcasting content and identification information of the external device providing the broadcasting content, and based on receiving a second user input corresponding to a home user interface (UI) button of a remote controller, display a home UI comprising a list of applications providing content, and the broadcasting content that is most recently displayed.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a method, performed by a display device, of providing broadcasting content, according to one or more embodiments of the disclosure;

FIG. 2 is a device diagram of a display device according to one or more embodiments of the disclosure;

FIG. 3 is a flowchart of an operation, performed by a display device, of providing broadcasting content in a user interface for selecting content, according to one or more embodiments of the disclosure;

FIG. 4 illustrates a method, performed by a display device, of identifying at least one source device providing pieces of broadcasting content, according to one or more embodiments of the disclosure;

FIG. 5 illustrates a method, performed by a display device, of displaying broadcasting content of a recent channel, as the display device receives a user input for scrolling a page, according to one or more embodiments of the disclosure;

FIGS. 6A and 6B illustrate a method, performed by a display device, of moving broadcasting content, according to one or more embodiments of the disclosure;

FIG. 7 illustrates a method, performed by a display device, of outputting an audio signal of broadcasting content based on a movement position of the broadcasting content, according to one or more embodiments of the disclosure;

FIGS. 8A and 8B illustrate a method, performed by a display device, of displaying broadcasting content of a recent channel, together with an application, according to one or more embodiments of the disclosure;

FIG. 9 is a flowchart of a method, performed by a display device, of displaying broadcasting content of a recent channel, according to one or more embodiments of the disclosure;

FIGS. 10A and 10B illustrate a method, performed by a display device, of displaying broadcasting content of a recent channel, according to one or more embodiments of the disclosure; and

FIG. 11 is a block diagram of a display device according to one or more embodiments of the disclosure.

### DETAILED DESCRIPTION

Hereinafter, example embodiments of the disclosure will be described in detail with reference to the accompanying drawings for one of ordinary skill in the art to easily execute the disclosure. However, the disclosure may have different forms and should not be construed as being limited to the embodiments described herein. In the drawings, parts not related to descriptions are omitted for the clear description of the disclosure, and throughout the specification, like reference numerals are used for like elements.

The terms used in the disclosure are common terms that are currently widely used, in consideration of their function in the disclosure. However, the terms may become different according to an intention of one of ordinary skill in the art, a precedent, or the advent of new technology. Therefore, the terms used in the disclosure should not be interpreted merely by the terms, but should be interpreted based on the meaning of the terms and the content throughout the disclosure.

In the terms such as “the first,” “the second,” etc. may be used to describe various components, but the components are not limited by these terms. The terms are used only for distinguishing one component from another component.

In the terms used in the disclosure are merely used to describe a pre-determined embodiment of the disclosure and are not aimed to limit the disclosure. Unless a singular meaning is apparent contextually, a singular expression may include a plural meaning. In addition, throughout the specification, when a part is referred to as being “connected” to other parts, the part may be “directly connected” to the other parts or may be “electrically connected” to the other parts with other devices therebetween. Furthermore, when a part “includes” a certain element, unless it is specifically mentioned otherwise, the part may further include another component and may not exclude the other component.

The expression “in some embodiments” or “according to one or more embodiments of the disclosure” described in various parts of this specification does not necessarily refer to the same embodiment.

According to embodiments of the disclosure, a display device for providing broadcasting content and an operating method of the display device are provided.

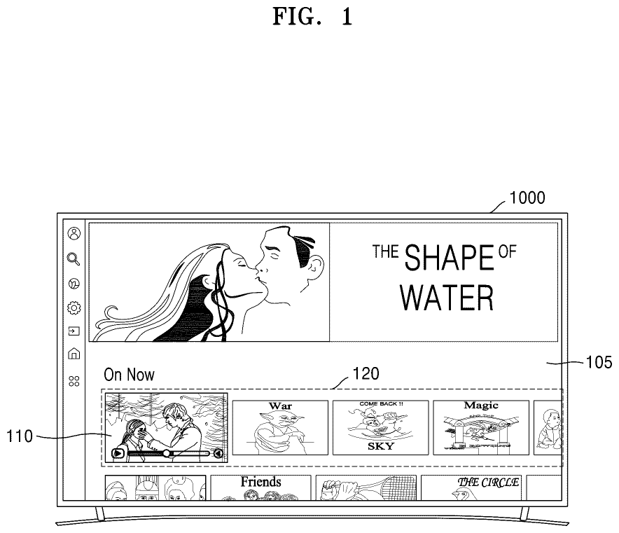

FIG. 1 illustrates a method, performed by a display device, of providing broadcasting content, according to one or more embodiments of the disclosure.

Referring to FIG. 1, a display device 1000 may provide information about broadcasting content in a home user interface (UI) page 105 configured to select content. The display device may receive a user input (e.g., first user input) for displaying broadcasting content received form an external device through an input and output port.

The display device 1000 may receive a user input (e.g., second user input) for displaying the home UI page 105. The home UI page 105 may be configured to provide a list of content that can be viewed in the display device 1000. The home UI page 105 may include a list 120 of pieces of broadcasting content. In one or more examples, the home UI page 105 may include a list of content that may be synchronized to a device (e.g., a game machine) connected to the display device 100. In one or more examples, the home UI page 105 may include a list of applications providing content. The screen in which content is displayed on the display device 100 may be referred to as a display screen.

In one or more examples, when the display device 1000 receives a user input for displaying the home UI page 105, the display device 1000 may reproduce, as one of the list of the broadcasting content, content 110 received from a channel (hereinafter, a recent channel) of broadcasting content that is most recently output. In one or more examples, most recently output content may include content that is currently being output, or content that was last outputted and terminated. A content reproduction image displayed as identification information of content or identification information of a channel may be referred to as a picture in guide (PIG). For example, the display device may display, on the at least the portion of the home UI, the channel identification information, stored in the memory, as identification information of the broadcasting content output prior to the display of the home UI. The content reproduction image may correspond to the identification information of the broadcasting content.

For example, when the display device 1000 receives the user input for displaying the home UI page 105 while outputting broadcasting content, the display device 1000 may reproduce, on the home UI page 105, as one of selectable pieces of content, the broadcasting content 110 that is being viewed. Accordingly, a user may continually view the content that is being viewed, while the user is provided one or more options to select other content different from the broadcasting content.

In one or more examples, when the user input for displaying the home UI page 105 or a user input for turning on the display device 1000 is received while content of an over-the-top (OTT) application is being output, the display device 1000 may reproduce the content 110 that is received from a broadcasting channel and was the content that was previously output from among previously output broadcasting channels.

Accordingly, a user may view content of a channel in which the user was interested, while watching a list of pieces of content, and may advantageously select a channel of interest with more ease.

According to one or more embodiments, when the display device 1000 displays the list 120 of broadcasting content, the display device 1000 may display identification information of a recent channel by distinguishing the identification information of the recent channel from identification information of the remaining channels. For example, referring to FIG. 1, the display device 1000 may indicate identification information of channels by using images of content received from the channels. In this case, the display device 1000 may indicate the identification information of the recent channel by using a motion image of the content 110 received from the recent channel at a time point at which the home UI is displayed and may indicate the identification information of each of the remaining channels by using a thumbnail image of content received from the channel. In one or more examples, the content of each channel may include an identifier that identifies a respective channel. For example, the content may be received as a data packet in which a field of the data packet (e.g., header) specifies a unique identifier of the channel.

According to one or more embodiments, the display device 1000 may display the identification information of the recent channel preferentially to the identification information of the remaining channels. For example, referring to FIG. 1, the display device 1000 may first display the motion image of the content 110, which is the identification information of the recent channel more prominently (e.g., highlighted image, larger image, or first image in list of images) than thumbnail images of remaining channels.

According to one or more embodiments, when the display device 1000 receives a user input (e.g., third user input) of selecting the content 110 of the recent channel or the channel identification displayed on the home UI, the display device 1000 may determine the content 110 of the recent channel as viewing content of the user and may reproduce the viewing content of the user on the entire screen of the display device. For example, when a predetermined reference time passes after the content 110 of the recent channel is focused according to the user input, the content that is being reproduced may be reproduced on the entire display portion.

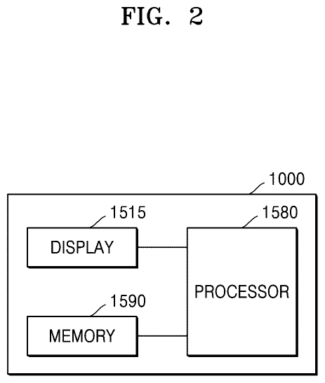

FIG. 2 is a device diagram of a display device 1000 according to one or more embodiments of the disclosure.

Referring to FIG. 2, the display device 1000 may include a display 1515, a memory 1590, and a processor 1580.

The memory 1590 may store various information, data, instructions, programs, etc. required for operations of the display device 1000. The memory 1590 may store one or more instructions.

The processor 1580 may be configured to control one or more operations of the display device 1000. The processor may be configured to execute the one or more instructions stored in the memory 1590 to control the components of the display device 1000.

The display 1515 may display information processed by the display device 1000 according to control by the processor 1580. For example, the display 1515 may display a UI or a graphical user interface (GUI) for controlling the display device 1000. In one or more examples, the display 1515 may output video data of content in the form of an image.

According to one or more embodiments, the processor 1580 may identify at least one source device receiving pieces of broadcasting content from among a plurality of source devices connected to the display device 1000. The at least one source device may be a set-top box receiving content through a cable. The at least one source device may be a TV receiving content wirelessly via the internet.

According to one or more embodiments, the processor 1580 may receive, through a user input device, a user input for displaying a list of a plurality of pieces of content which may be reproduced through the display device 1000.

According to one or more embodiments, when the processor 1580 receives a user input, the processor 1580 may identify a source device providing broadcasting content most recently output through the display from among the plurality of source devices connected to the display device 1000 and a channel of the broadcasting content that is output. For example, the source device may be stick device providing an internet TV streaming service that provides content through the internet, the broadcasting content may be a new program, and the channel may be CNN or MSNBC.

According to one or more embodiments, while the processor 1580 displays a screen including a list of a plurality of pieces of content, the processor 1580 may control the identified source device to reproduce, on at least a portion of the screen, content of the channel of the broadcasting content that is most recently output. For example, a portion of the screen may display a TV show or program while also simultaneously displaying icons or thumbnail images of other content.

According to one or more embodiments, when the processor 1580 receives a user input of selecting the reproduced content, the processor 1580 may reproduce the content on the entire screen.

The display device 1000 may include all of electronic devices which may visually output video content. In detail, the display device 1000 may include a television (TV), a digital broadcasting terminal, a tablet personal computer (PC), a smartphone, a mobile phone, a computer, a notebook computer, etc. In one or more examples, the display device 1000 may include not only a stationary type, but also may include a mobile type or a portable type.

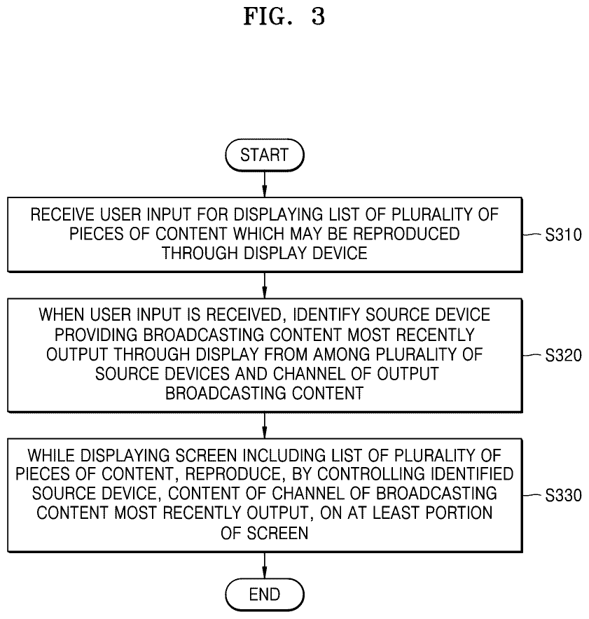

FIG. 3 is a flowchart of an operation, performed by a display device, of providing broadcasting content in a UI for selecting content, according to one or more embodiments of the disclosure.

In operation S310, the display device 1000 may receive a user input for displaying a list of a plurality of pieces of content which may be reproduced through the display device 1000.

The user input for displaying the list of the plurality of pieces of content which may be reproduced through the display device 1000 may include, but is not limited to, a user input of pressing a home UI button of a remote controller.

In operation S320, when the display device 1000 receives a user input, the display device 1000 may identify a source device providing broadcasting content most recently output through the display from among the plurality of source devices connected to the display device 1000 and a channel of the broadcasting content that is output.

According to one or more embodiments, the display device may identify, based on data received from the plurality of source devices, a source device transmitting electronic program guide (EPG) information as the at least one source device receiving pieces of broadcasting content.

According to one or more embodiments, the display device 1000 may receive, from a plurality of source devices, identification information indicating types of the devices and may identify, based on the identification information, one or more source devices receiving pieces of broadcasting content.

The display device 1000 may identify, from among the identified one or more source devices, a source device providing broadcasting content most recently output through a display, and a channel of the output broadcasting content.

Based on user's channel selection, the display device 1000 may pre-store viewing information. For example, when the display device 1000 receives a user input of changing the channel, the display device 1000 may store identification information of the changed channel and identification information of a source device providing content of the channel. Accordingly, the display device 1000 may obtain identification information of the source device providing the broadcasting content most recently output and identification information of the channel of the output broadcasting content.

According to one or more embodiments, the display device 1000 may determine a recent channel by taking into account a user's viewing history. For example, the display device 1000 may determine the recent channel by taking into account the day of the week and the time at which a user input of displaying a list of content is received. To this end, the display device 1000 may store the recently output channel correspondingly to the days of the week and the time. For example, when a channel 100 is output from a first source on 7 p.m. on Tuesday, the display device 1000 may store the first source and the channel 100 correspondingly to 7 p.m. on Tuesday. Thereafter, when the display device 1000 receives the user input of displaying the list of content on 7 p.m. on next Tuesday, the display device 1000 may obtain, as the source device of the recent channel and the channel stored correspondingly to 7 p.m. on Tuesday, the first source and the channel 100, and may reproduce, by controlling the first source, content received from the channel 100 on a portion of the home UI page, together with the list of content.

In operation S330, while the display device 1000 may display a screen including a list of a plurality of pieces of content, the display device 1000 may reproduce, by controlling the identified source device, content of the channel of the most recently output broadcasting content.

Based on the identification information of the source device and the identification information of the channel, the display device 1000 may obtain, by controlling the identified source device, a broadcasting signal of the identified channel. In one or more examples, based on the obtained broadcasting signal, the display device 1000 may reproduce broadcasting content of the recent channel.

The list of the plurality of pieces of content may include a list of pieces of broadcasting content received from a plurality of channels. According to one or more embodiments, the display device 1000 may preferentially display the content received from the channel of the broadcasting content most recently output from among the plurality of channels with respect to the pieces of content received from the remaining channels. For example, the display of an image of the broadcasting content from among the list of the plurality of pieces of broadcasting content corresponding to the plurality of channels may be displayed with a higher priority or in a manner different to content images corresponding to remaining channels different from a channel associated with the broadcasting content. For example, an image of the content that was displayed prior to the display of the home UI screen may be the first displayed image in a list of images or may be highlighted or enlarged with respect to the other content of the remaining channels.

According to one or more embodiments, the display device 1000 may receive, through a user input device (e.g., input device such as a remote, touch screen on a phone, etc.), a user input for scrolling the list of the plurality of pieces of content, and when a reproduction portion of content deviates from a display portion of the display while the list of the plurality of pieces of content is being scrolled, the reproduction portion of the content may be moved into the display portion.

According to one or more embodiments, when the display device 1000 moves the reproduction portion of the content into the display portion, the display device 1000 may display an image indicating a movement direction of the content.

According to one or more embodiments, the display device 1000 may determine at least one speaker from among a plurality of speakers connected to the display device 1000 based on a movement position of the reproduction portion of the content and may output an audio signal of the content through the determined at least one speaker.

According to one or more embodiments, when the display device 1000 receives the user input for displaying the list of the plurality of pieces of content, the display device 1000 may reproduce the content on a channel selection portion, and, after the reproduction portion of the content is moved into the display portion, the display device 1000 receives a user's scroll input to have the channel selection portion appear again, the display device 1000 may move again the reproduction portion of the content into the channel selection portion.

According to one or more embodiments, when the display device 1000 receives a user input for scrolling the list of the plurality of pieces of content, the display device 1000 may change focus content that is focused from among the plurality of pieces of content, and may determine a size of the reproduction portion and a position of the reproduction portion such that the focus content and the reproduction portion of the content do not overlap each other and may move the reproduction portion of the content into the display portion based on the determined size and position of the reproduction portion.

According to one or more embodiments, when the display device 1000 receives the user input for displaying the list of the plurality of pieces of content, the display device 1000 may display icons of applications providing the pieces of content, together with the list of the plurality of pieces of content. In one or more examples, when the display device 1000 receives a user input of selecting an icon of an application, the display device 1000 may reproduce content received from an identified channel, together with a list of pieces of content provided by the application.

According to one or more embodiments, when a viewing history is not stored in the display device 1000, the display device 1000 may reproduce broadcasting content of a channel most frequency watched, based on information included in a broadcasting signal, and may reproduce broadcasting content of a channel designated as a popular channel.

When the display device 1000 receives a user input of selecting the reproduced content, the display device 1000 may reproduce the content on the entire screen.

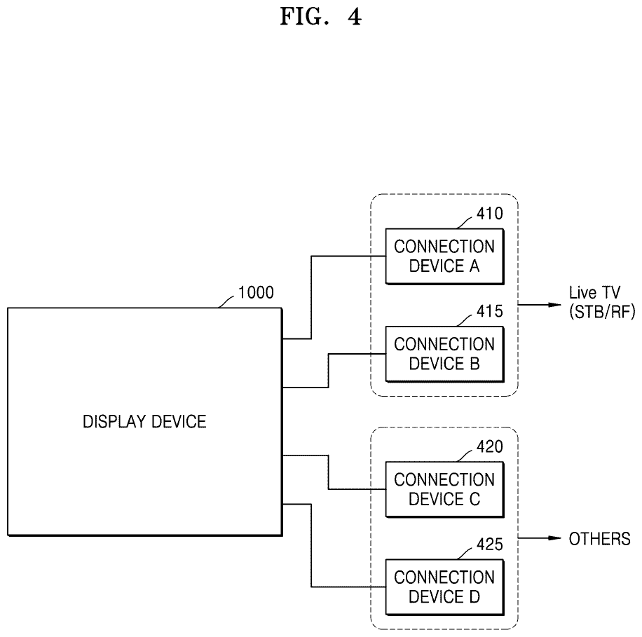

FIG. 4 illustrates a method, performed by a display device, of identifying at least one source device providing pieces of broadcasting content, according to one or more embodiments of the disclosure.

Referring to FIG. 4, the display device 1000 may be connected to at least one source device providing pieces of broadcasting content.

The at least one source device providing the pieces of broadcasting content may include a tuner. The tuner may select a channel by tuning only a frequency of a channel to be received by the display apparatus 100 from among many frequency components included in a broadcasting signal through amplification, mixing, resonance, etc. on a broadcasting signal received in a wired or wireless manner. For example, the at least one source device receiving the pieces of broadcasting content may include a ground-wave broadcasting receiver, a satellite broadcasting receiver, a cable broadcasting receiver, etc. but is not limited thereto.

The at least one source device providing the pieces of broadcasting content may be integrally provided with the display device 1000 and may be included in the display device 1000, or may be provided as a separate device such as a set-top box and may be connected to the display device 1000 through an inputter/outputter of the display device 1000.

According to one or more embodiments, the display device 1000 may identify at least one source device providing pieces of broadcasting content from among a plurality of source devices connected to the display device 1000.

The display device 1000 may be connected to various devices through the inputter/outputter. For example, the display device 1000 may be connected to a ground-wave broadcasting set-top box, a cable broadcasting set-top box, a satellite broadcasting set-top box, an Internet broadcasting set-top box, a game machine, a speaker, an OTT set-top box, a multimedia streaming adaptor, etc., but is not limited thereto.

Referring to FIG. 4, the display device 1000 may be connected to a ground-wave receiver 410, a satellite broadcasting set-top box 415, a game machine 420, and a speaker 425. In one or more examples, the ground-wave receiver 410 may be integrally provided with the display device 1000 and may be included in the display device 1000.

According to one or more embodiments, the display device 1000 may receive, from the plurality of source devices, identification information indicating a type of a respective device, and may identify, based on the received identification information, at least one source device providing pieces of broadcasting content from among the plurality of source devices.

For example, the display device 1000 may store pieces of identification information of the source devices providing the broadcasting content. The display device 1000 may periodically receive, from a server, the pieces of identification information of the source devices providing the broadcasting content. Accordingly, when the identification information received from the source device is the same as one of the pieces of stored identification information, the display device 1000 may determine the source device transmitting the received identification information as a device providing the broadcasting content.

In one or more examples, the display device 1000 may identify the at least one source device providing the pieces of broadcasting content from among the plurality of source devices, based on information included in data received from the source device. For example, when EPG information is included in the data received from the source device, the display device 1000 may determine the source device transmitting the EPG information as a device providing the pieces of broadcasting content.

In one or more examples, when the display device 1000 receives video data from a source device, outputs a frame based on the received data, and identifies channel information from the frame by image-processing the frame, the display device 1000 may determine the source device transmitting the video data as a device providing the pieces of broadcasting content.

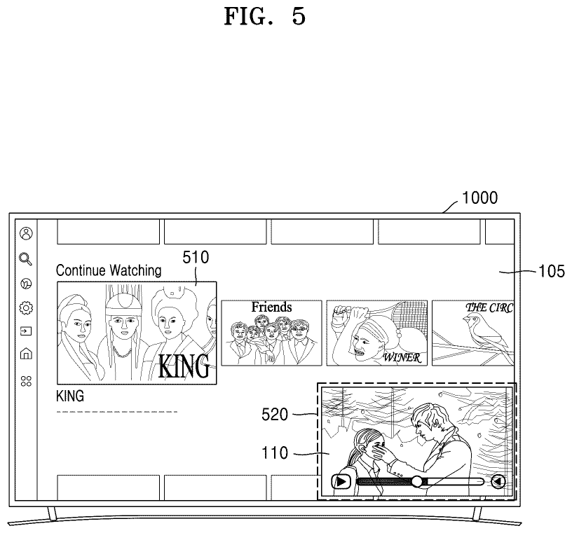

FIG. 5 illustrates a method, performed by a display device, of displaying broadcasting content of a recent channel, as the display device receives a user input for scrolling a page, according to one or more embodiments of the disclosure.

Referring to FIG. 5, when the display device 1000 receives a user input for scrolling the home UI page 105, the display device 1000 may move the broadcasting content 110 of a recent channel that is being reproduced.

For example, when the home UI page 105 is larger than a display screen and when the user input for scrolling the page is received, a reproduction portion 520 of the broadcasting content displayed on the page may deviate from a display portion. For example, while the content is currently being reproduced, reception of a scrolling input for scrolling the home UI page 105 may cause the display of the content to be displaced from a first display portion to a second display portion. In one or more examples, the display device 1000 may move the reproduction portion 520 of the broadcasting content into the display portion. Thus, even when the page is scrolled, a user may keep watching the broadcasting content. For example, when a user input for scrolling down the page is received, the display device 1000 may move the reproduction portion 520 of the broadcasting content downwards.

According to one or more embodiments, the display device 1000 may change at least one of a size and a position of the reproduction portion such that focused content 510 and the reproduction portion 520 of the broadcasting content do not overlap each other in the home UI page 105.

The focused content 510 may denote content selected according to a user input (e.g., a user's scroll input or input of a direction button), and identification information of the focused content 510 may be displayed by being emphasized so as to be distinguished from identification information of other content.

The display device 1000 may change the size and the position of the reproduction portion such that the focused content 510 and the reproduction portion 520 of the broadcasting content do not overlap each other and may continually reproduce the broadcasting content based on the changed size and position of the reproduction portion.

According to one or more embodiments, the display device 1000 may display, on the reproduction portion 520 of the broadcasting content, an image or text indicating the broadcasting content received from the recent channel. For example, the display device may display, on the image of the broadcasting content, an image or text indicating a channel of the broadcasting or the broadcasting content output prior to the display of the home UI. In one or more examples, the display device may display, on the at least the portion of the home UI, the channel identification information, stored in the memory, as identification information of the broadcasting content output prior to the display of the home UI.

According to one or more embodiments, the display device 1000 may provide a UI for selecting whether or not to reproduce the broadcasting content 110 on the home UI page 105. When the display device 1000 receives, through the UI, a user input of selecting not to reproduce the broadcasting content 110 on the home UI page 105, the display device 1000 may not reproduce the broadcasting content 110 on the home UI page 105.

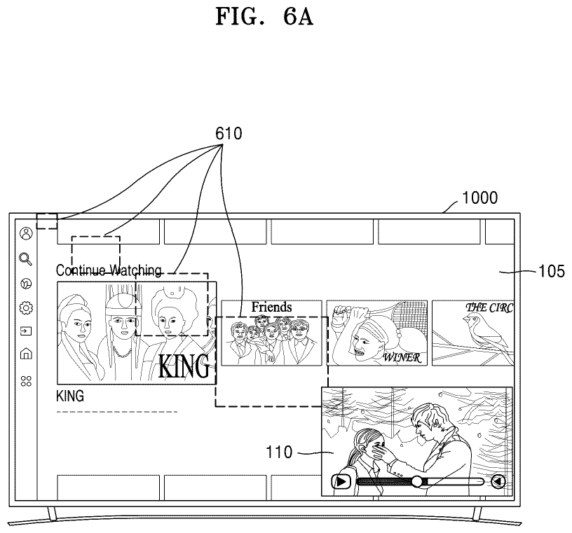

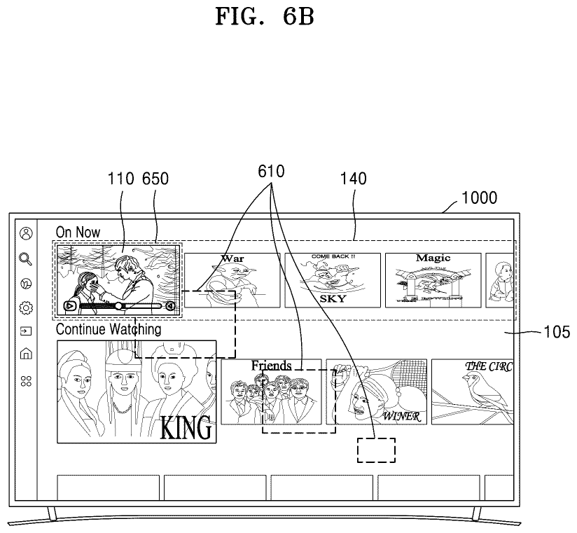

FIGS. 6A and 6B illustrate a method, performed by a display device, of moving broadcasting content, according to one or more embodiments of the disclosure.

Referring to FIG. 6A, when the broadcasting content 110 is moved, the display device 1000 may display an image 610 indicating a movement direction of the broadcasting content 110.

For example, when a reproduction portion of the broadcasting content 110 is moved from an upper left end to a lower right end of the home UI page 105, the display device 1000 may display the image 610 indicating that the reproduction portion of the broadcasting content 110 is moved from the upper left end to the lower right end.

Referring to FIG. 6B, when, after the home UI page 105 is scrolled, a reproduction portion 650 before the movement according to a user input for scrolling the home UI page 105 enters into the display portion again, the display device 1000 may move the broadcasting content 110 to the reproduction portion 650 before the movement.

Here, the display device 1000 may also display the image 610 indicating a movement direction of the broadcasting content.

When a user input of selecting the broadcasting content 110 is received after the broadcasting content 110 of a recent channel is moved again to a portion 140 on which a list of pieces of broadcasting content is displayed, the display device 1000 may change the reproduction portion of the broadcasting content 110 to the entire display portion.

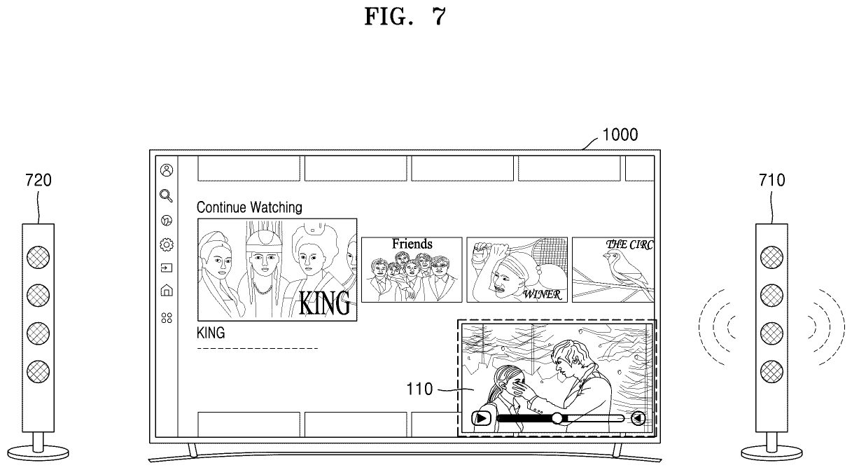

FIG. 7 illustrates a method, performed by a display device, of outputting an audio signal of broadcasting content based on a movement position of the broadcasting content, according to one or more embodiments of the disclosure.

Referring to FIG. 7, the display device 1000 may determine an output position of the audio signal of the broadcasting content, based on the movement position of the broadcasting content 110.

In one or more examples, the display device 1000 may be connected to a plurality of speakers 710 and 720, and the output position of the audio signal may be determined to correspond to each speaker. For example, when a first speaker 710 is connected to a right output signal terminal of the display device 1000, the output position of the first speaker 710 may be the right side. In one or more examples, even when only one speaker is connected to the display device 1000, a right built-in speaker and a left built-in speaker may be included in the speaker, and when the right built-in speaker is connected to the right output signal terminal of the display device 1000, the output position of the right built-in speaker may be the right side.

When the reproduction portion of the broadcasting content 110 is moved from the left side to the right side of a display portion, the display device 1000 may output the audio signal through only the right output signal terminal of the plurality of speakers connected to the display device 1000. Thus, the audio signal of the broadcasting content 110 may be output through only the first speaker 710 connected to the right output signal terminal.

Thus, a user may intuitively identify the movement position of the broadcasting content of the recent channel based on the output position of the audio signal.

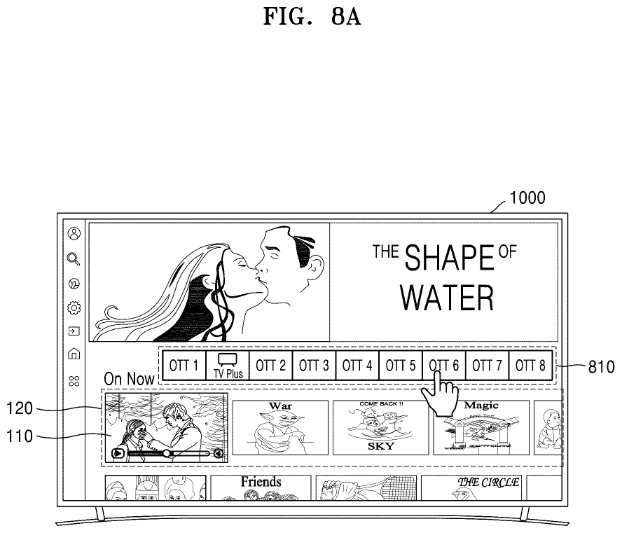

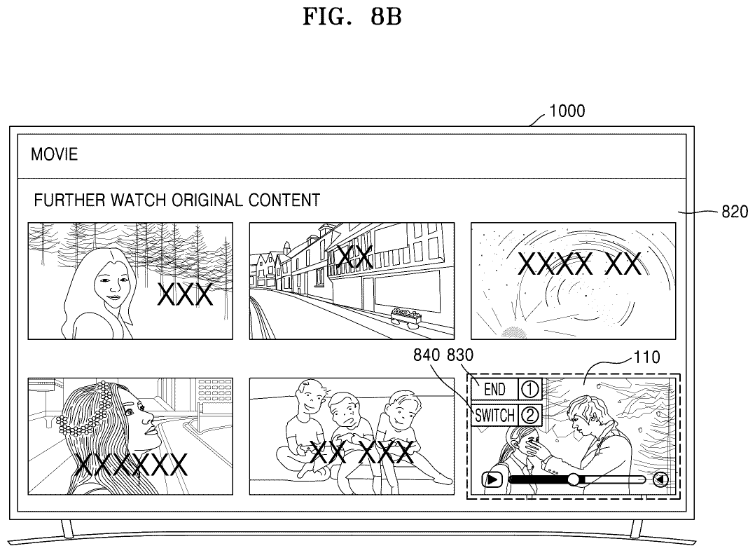

FIGS. 8A and 8B illustrate a method, performed by a display device, of displaying broadcasting content of a recent channel, together with an application, according to one or more embodiments of the disclosure.

Referring to FIG. 8A, when the display device 1000 receives a user input for displaying the home UI page 105, the display device 1000 may display a list 810 of OTT applications together with the list 120 of the broadcasting content. In one or more examples, the display device 1000 may receive a user input of selecting an OTT application.

Referring to FIG. 8B, when the display device 1000 executes the OTT application, the display device 1000 may reproduce the broadcasting content 110 of the recent channel together with content information 820 in the OTT application. Thus, a user may watch the broadcasting content 110 even when the user searches for content in the OTT application.

According to one or more embodiments, the display device 1000 may reproduce the broadcasting content 110 of the recent channel together with the content of the OTT application, even when the display device 1000 reproduces the content in the OTT application.

According to one or more embodiments, when the display device 1000 receives a user input of selecting content in the OTT application, the display device 1000 may delete the broadcasting content 110 of the recent channel that is being reproduced and may reproduce the content in the OTT application.

According to one or more embodiments, when the display device 1000 reproduces the broadcasting content 110 of the recent channel, the display device 1000 may display a UI 830 for deleting the broadcasting content 110 that is being reproduced or a UI 840 for reproducing the broadcasting content that is being reproduced on the entire screen.

In one or more examples, the UIs 830 and 840 for controlling the broadcasting content 110 that is being reproduced may include identification information of corresponding buttons. For example, information may be displayed that the UI 830 for deleting the broadcasting content that is being reproduced may be selected through a button 1 of a remote controller, and the UI 840 for reproducing the broadcasting content that is being reproduced on the entire screen may be selected through a button 2 of the remote controller.

When the display device 1000 receives a user input of selecting the UI 830 for deleting the broadcasting content that is being reproduced, the display device 1000 may delete the broadcasting content that is being reproduced. In one or more examples, when the display device 1000 receives a user input of selecting the UI 840 for reproducing the broadcasting content that is being reproduced on the entire screen, the display device 1000 may reproduce the broadcasting content 110 that is being reproduced on the entire screen.

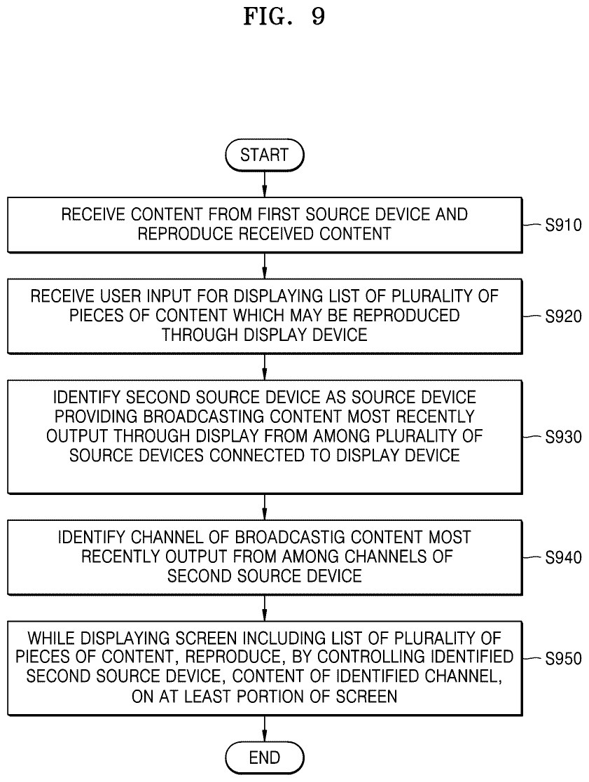

FIG. 9 is a flowchart of a method, performed by a display device, of displaying broadcasting content of a recent channel, according to one or more embodiments of the disclosure.

In operation S910, the display device 1000 may receive content from a first source device and may reproduce the received content.

The first source device may not include a tuner. For example, the first source device may include a game machine or an OTT set-top box, but is not limited thereto.

In operation S920, the display device 1000 may receive a user input for displaying a list of a plurality of pieces of content which may be reproduced through the display device 1000. Operation S820 may be described by referring to operation S330 of FIG. 3.

In operation S930, the display device 1000 may identify a second source device as a source device providing broadcasting content that is most recently output through a display from among a plurality of source devices connected to the display device 1000.

The display device 1000 may store information about broadcasting content that is most recently output. For example, the information about the broadcasting content most recently output may include identification information of the source device providing the broadcasting content most recently output and identification information of a channel.

Accordingly, based on the information about the broadcasting content most recently output, the display device 1000 may obtain identification information of the second source device as the source device providing the broadcasting content most recently output from among the plurality of source devices.

The second source device may include a tuner. The second source device may include, for example, a ground-wave broadcasting set-top box, a cable broadcasting set-top box, and a satellite broadcasting set-top box, but is not limited thereto.

In operation S940, the display device 1000 may identify a channel of the broadcasting content most recently output from among channels of the second source device.

The display device 1000 may obtain, based on the information about the broadcasting content most recently output, identification information of the channel of the broadcasting content most recently output.

In operation S950, while the display device 1000 displays a screen including the list of the plurality of pieces of content, the display device 1000 may reproduce, by controlling the identified second source device, content of the identified channel, on at least a portion of the screen.

According to one or more embodiments, the display device 1000 may reproduce, on the home UI page 105, the content of the recent channel or content of the recent channel corresponding to the days of the week and the time, based on whether or not the display device 1000 receives a user input while a user is watching broadcasting content.

For example, when the display device 1000 receives a user input for displaying the home UI page 105 while the display device 1000 outputs the broadcasting content, the display device 1000 may display, on a portion of the home UI page 105, the broadcasting content that is being output. When the display device 1000 receives a user input for displaying the home UI page 105 while the display device 1000 outputs other content (e.g., content received from a game machine) than the broadcasting content, the display device 1000 may reproduce the content of the recent channel stored to correspond to the day and the time of a time point at which the user input is received. For example, when the time point at which the user input is received is 7 o'clock on Tuesday, a source device and a channel providing most recent broadcasting content that is output on 7 o'clock Tuesday may be identified, and based on the identified source device and channel, the most recent broadcasting content of the channel that is output on 7 o'clock on Tuesday may be reproduced.

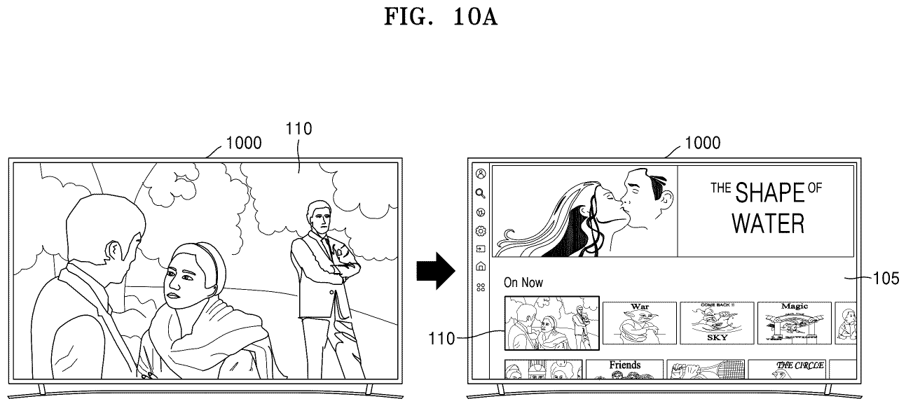

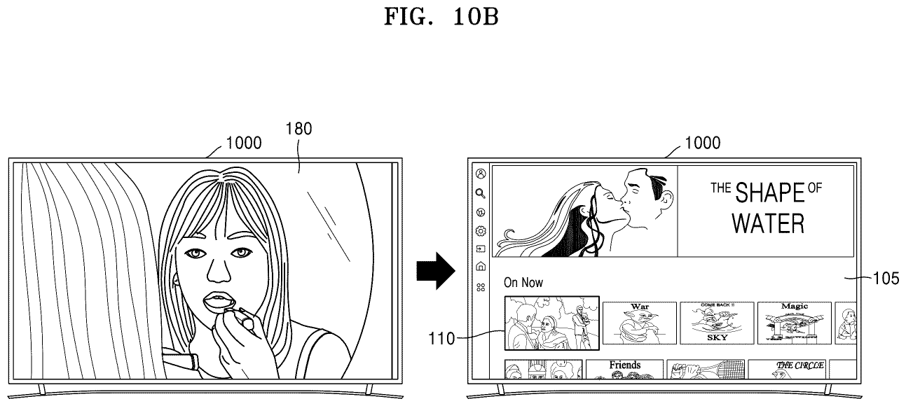

FIGS. 10A and 10B illustrate a method, performed by a display device, of displaying broadcasting content of a recent channel, according to one or more embodiments of the disclosure.

Referring to FIG. 10A, when the display device 1000 receives a user input for displaying the home UI page 105 while the display device 1000 outputs the broadcasting content 110, the display device 1000 may continually output, on a portion of the home UI page 105, the broadcasting content 110 that is being output.

For example, the display device 1000 may receive the broadcasting content 110 of a channel 100 from a cable broadcasting set-top box and may reproduce the received broadcasting content 110 on the entire display portion. In this case, the display device 1000 may store identification information of the cable broadcasting set-top box, as identification information of a source device providing broadcasting content most recently output. In one or more examples, the display device 1000 may store “100” as identification information of a channel of the broadcasting content most recently output.

When the display device 1000 receives the user input for displaying the home UI page 105 while the display device 1000 reproduces the broadcasting content 110, the display device 1000 may identify the cable broadcasting set-top box as the source device providing the broadcasting content most recently output through a display from among a plurality of source devices connected to the display device 1000 and may identify “100” as the identification information of the channel of the broadcasting content most recently output.

While the display device 1000 may display a screen including a list of a plurality of pieces of content, the display device 1000 may reproduce, by controlling the identified cable broadcasting set-top box, content of the identified channel 100 on at least a portion of the screen. Accordingly, a user may continually view the content that the user has been viewing.

Referring to FIG. 10B, when the display device 1000 receives a user input for displaying the home UI page 105 while the display device outputs game content 180 received from a game machine, the display device 1000 may output the broadcasting content 110 of the most recent channel on a portion of the home UI page 105.

For example, the display device 1000 may receive the game content 180 from the game machine and may display the received game content 180 on the entire display portion. This case may correspond to a state in which, before the display device 1000 displays the game content 180, the display device 1000 may receive the broadcasting content 110 of the channel 100 from the cable broadcasting set-top box, and while the display device 1000 reproduces the received broadcasting content 110, the display device 1000 may receive the game content 180 from the game machine according to a user input and may display the received game content 180.

Accordingly, the display device 1000 may store identification information of the cable broadcasting set-top box as identification information of a source device providing broadcasting content most recently output. In one or more examples, the display device 1000 may store “100” as identification information of a channel of the broadcasting content most recently output.

When the display device 1000 receives the user input for displaying the home UI page 105 while the display device 1000 reproduces the game content 180, the display device 1000 may identify the cable broadcasting set-top box as the source device providing the broadcasting content most recently output through the display from among the plurality of source devices connected to the display device 1000 and may identify “100” as the identification information of the channel of the broadcasting content most recently output.

While the display device 1000 may display a screen including a list of a plurality of pieces of content, the display device 1000 may reproduce, by controlling the identified cable broadcasting set-top box, content of the identified channel 100 on at least a portion of the screen. Accordingly, a user may continually view content of the channel most recently output.

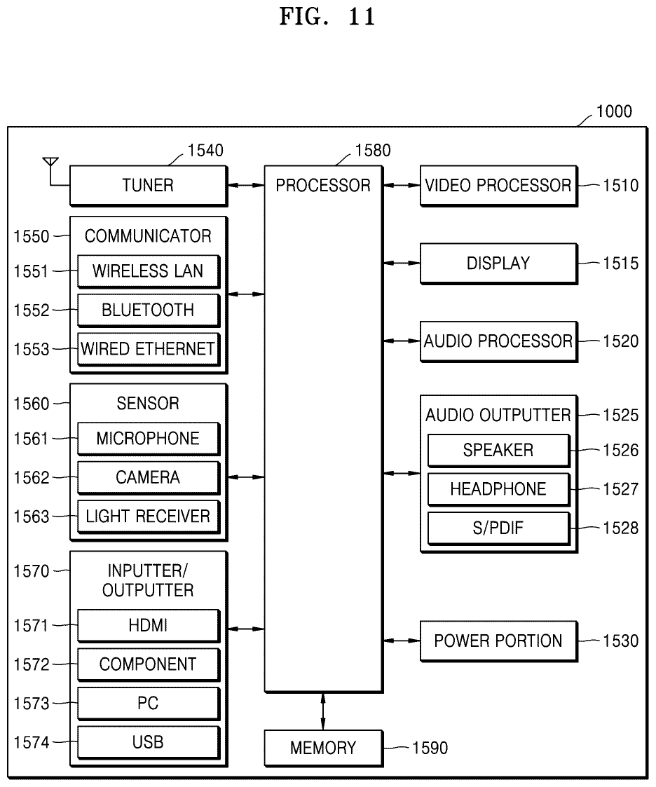

FIG. 11 is a block diagram of a display device according to one or more embodiments of the disclosure.

Referring to FIG. 11, the display device 1000 may include a video processor 1510, the display 1515, an audio processor 1520, an audio outputter 1525, a power portion 1530, a tuner 1540, a communicator 1550, a sensor 1560, an inputter/outputter 1570, the processor 1580, and the memory 1590. The display 1515 and the processor 1580 in FIG. 11 may correspond to the display 1515 and the processor 1580, respectively, in FIG. 2. Each of the components of the display device may be implemented by circuitry. In one or more examples, the inputter/outputter 1570 may be referred to as an input and output port. The communicator 1550 may be referred to as communication circuitry.

However, not all of the components illustrated in FIG. 11 are essential components of the display device 1000. The display device 1000 may be realized by including more or less components than the components illustrated in FIG. 11.

In one or more examples, the video processor 1510 may process video data received by the display device 1000. The video processor 1510 may perform various image processing operations on the video data, such as decoding, scaling, noise filtering, frame rate conversion, resolution conversion, etc.

In one or more examples, the display 1515 may display, on a screen, video included in a broadcasting signal received through the tuner 1540, according to control by the processor 1580. In one or more examples, the display 1515 may display content (for example, video) that is input through the communicator 1550 or the inputter/outputter 1570. In one or more examples, the display 1515 may output an image stored in the memory 1590, according to control by the processor 1580. In one or more examples, the display 1515 may display a UI for controlling the display device 1000.

The audio processor 1520 may process audio data. The audio processor 1520 may perform various processing operations on the audio data, such as decoding, amplification, noise filtering, etc. The audio processor 1520 may include a plurality of audio processing modules for processing audio corresponding to a plurality of pieces of content.

The audio outputter 1525 may output audio included in a broadcasting signal received through the tuner 1540, according to control by the processor 1580. The audio outputter 1525 may output audio (e.g., a voice, sound, etc.) that is input through the communicator 1550 or the inputter/outputter 1570. In one or more examples, the audio outputter 1525 may output audio stored in the memory 1590, according to control by the processor 1580. The audio outputter 1525 may include at least one of a speaker 1526, a headphone output terminal 1527 or a Sony/Philips digital interface (S/PDIF) output terminal 1528. The audio outputter 1525 may include a combination of the speaker 1526, the headphone output terminal 1527, and the S/PDIF output terminal 1528.

In one or more examples, the power portion 1530 may supply power that is input from an external power source to the components 1510 to 1590 in the display device 1000, according to control by the processor 1580. In one or more examples, the power portion 1530 may supply power that is output from one or more batteries included in the display device 1000 to the components 1510 to 1590 in the display device 1000, according to control by the processor 1580.

In one or more examples, the tuner 1540 may tune and select only a frequency of a channel to be received by the display device 1000 from many radio wave components through amplification, mixing, resonance, etc. on a broadcasting signal received in a wired or wireless manner. The broadcasting signal may include audio, video, and additional information (e.g., an EPG).

The tuner 1540 may receive the broadcasting signal from a frequency band corresponding to a channel number (e.g., a cable broadcasting number 506) according to a control signal received from a user input (e.g., an external control device, such as a remote controller), such as an input of a channel number, an input of upward or downward scrolls through channels, a channel input on an EPG screen, etc.

The tuner 1540 may receive the broadcasting signal from various sources, such as ground-wave broadcasting, cable broadcasting, satellite broadcasting, Internet broadcasting, etc. The tuner 1540 may receive the broadcasting signal from sources, such as analog broadcasting or digital broadcasting. The broadcasting signal received through the tuner 1540 may be decoded (for example, audio-decoded, video-decoded, or additional data-decoded) and divided into audio data, video data and/or additional data. The divided audio, video, and/or additional data may be stored in the memory 1590 according to control by the processor 1580.

The tuner 1540 of the display device 1000 may include a single tuner or a plurality of tuners. According to one or more embodiments, when the tuner 1540 includes a plurality of tuners, a plurality of broadcasting signals may be output on a plurality of windows included in a multi-window screen provided in the display 1515.

The tuner 1540 may be realized as an all-in-one type with the display device 1000, as an additional device (e.g., a set-top box) having a tuner electrically connected to the display device 1000, or as a tuner connected to the inputter/outputter 1570.

The communicator 1550 may connect the display device 1000 to an external device (e.g., an audio device, etc.) according to control by the processor 1580. The processor 1580 may transmit/receive content to and from an external device connected to the processor 1580 through the communicator 1550, may download an application from the external device, or perform web-browsing. In detail, the communicator 1550 may receive content from an external device by accessing a network.

As described above, the communicator 1550 may include at least one of a short-range wireless communication module, a wired communication module, and a mobile communication module.

FIG. 11 illustrates a case in which the communicator 1550 includes one of a wireless local area network (LAN) 1551, a Bluetooth communicator 1552, and wired Ethernet 553, as an example.

In one or more examples, the communicator 1550 may include a module combination including one or more of the wireless LAN 1551, the Bluetooth communicator 1552, and the wired Ethernet 553. Also, the communicator 1550 may receive a control signal of a controller according to control by the processor 1580. The control signal may be realized as a Bluetooth type, a radio frequency (RF) signal type, or a Wi-Fi type.

The communicator 1550 may further include other short-range wireless communication (e.g., near field communication (NFC) and an additional Bluetooth low energy (BLE) module), in addition to Bluetooth.

In one or more examples, the sensor 1560 may sense a voice, an image, or interaction of a user. The sensor 1560 may include, for example, a camera 1562.

The sensor 1560 may include a camera 1562. In one or more examples, the sensor 1560 may further include at least one of a microphone 1561 and a light receiver 1563.

In one or more examples, the microphone 1561 may receive an uttered voice of a user. The voice received through the microphone 1561 may be converted into an electrical signal and processed by the processor 1580. The user's voice may include, for example, a voice corresponding to a menu or a function of the display device 1000. For example, a recommended recognition range of the microphone 1561 may be within 4 m from the microphone 1561 to a location of the user, and the recognition range of the microphone 1561 may be changed based on a volume of the voice of the user and ambient environment (e.g., a speaker sound, an ambient noise, etc.).

In one or more examples, the microphone 1561 may be realized as an integral type or a separate type with respect to the display device 1000. The microphone 1561 that is a separate type may be electrically connected to the display device 1000 through the communicator 1550 or the inputter/outputter 1570.

It may be easily understood by one of ordinary skill in the art that the microphone 1561 may be omitted according to the performance and the structure of the display device 1000.

The processor 1580 may select a menu displayed on the display device 1000 by using a result of motion recognition or may perform a control operation corresponding to the result of motion recognition. For example, the control operation may include a channel adjustment, a volume adjustment, a cursor movement, etc.

In one or more examples, the camera 1562 may include a lens and an image sensor. The camera 1562 may support optical zooming or digital zooming by using a plurality of lenses and image processing. A recognition range of the camera 1562 may be set in various ways according to an angle of the camera and conditions of an ambient environment. When the camera 1562 includes a plurality of cameras, a three-dimensional still image or a three-dimensional motion may be received by using the plurality of cameras.

The camera 1562 may be realized as an integral type or a separate type with respect to the display device 1000. An additional device including the camera 1562 that is a separate type may be electrically connected to the display device 1000 through the communicator 1550 or the inputter/outputter 1570.

It may be easily understood by one of ordinary skill in the art that the camera 1562 may be omitted according to the performance and the structure of the display device 1000.

In one or more examples, the light receiver 1563 may receive an optical signal (including a control signal) from an external controller through an optical window of a bezel of the display 1515. The light receiver 1563 may receive an optical signal corresponding to a user input (e.g., a touch input, a press input, a touch gesture, a voice, or a motion) from a controller. A control signal may be extracted from the received optical signal according to control by the processor 1580.

In one or more examples, the inputter/outputter 1570 may receive video (for example, a motion picture, etc.), audio (for example, a voice, music, etc.), and additional data (for example, an EPG, etc.) from the outside of the display device 1000, according to control by the processor 1580. The inputter/outputter 1570 may include one of a high-definition multimedia interface (HDMI) port 1571, a component jack 1572, a personal computer (PC) port 1573, and a universal serial bus (USB) port 1574. The inputter/outputter 1570 may include a combination of the HDMI port 1571, the component jack 1572, the PC port 1573, and the USB port 1574.

It may be easily understood by one of ordinary skill in the art that the structure and the operation of the inputter/outputter 1570 may be realized in various ways according to one or more embodiments of the disclosure.

The processor 1580 may control general operations of the display device 1000, control signal flows between the components included in the display device 1000, and process data. When there is a user input or a condition predetermined and stored is met, the processor 1580 may execute an operation system (OS) stored in the memory 1590 and various applications.

The processor 1580 may include random-access memory (RAM) used as a storage for storing signals or data input from the outside of the display device 1000 or as a storage corresponding to various operations performed by the display device 1000, read-only memory (ROM) storing control programs for controlling operations by the display device 1000, and a processor.

The processor may include a GPU for processing graphics data corresponding to video data. The processor may be realized as a system on chip (SoC) combining a core and a GPU. The processor may include a single core, a dual core, a triple core, a quad core, and its multiple core.

In one or more examples, the processor may include a plurality of processors. For example, the processor may be realized as a main processor and a sub-processor operating in a sleep mode.

Machine-readable storage media may be provided as non-transitory storage media. Here, the term “non-transitory storage media” only denotes that the media are tangible devices and do not include signals (e.g., electromagnetic waves), and does not distinguish the storage media semi-permanently storing data and the storage media temporarily storing data. For example, the “non-transitory storage media” may include a buffer temporarily storing data.

According to one or more embodiments, the method according to various embodiments disclosed in the present specification may be provided as an inclusion of a computer program product. The computer program product may be, as a product, transacted between a seller and a purchaser. The computer program product may be distributed in the form of a machine-readable storage medium (e.g., a compact disc (CD)-ROM) or may be distributed online (e.g., downloaded or uploaded) through an application store or directly between two user devices (e.g., smartphones). In the case of online distribution, at least part of a computer program product (e.g., a downloadable application) may be at least temporarily stored in a machine-readable storage medium, such as a server of a manufacturer, a server of an application store, or a memory of a relay server, or may be temporarily generated.

What is claimed is:

1. A display device comprising:
a display;
a memory storing one or more instructions;
an input and output port configured to connect an external device with the display device, the external device providing broadcasting content; and
at least one processor operatively coupled to the memory and configured to execute one or more instructions stored in the memory,
wherein the one or more instructions, when executed by the at least one processor, cause the display device to:
based on reception of a first user input,
display, on the display, the broadcasting content received from the external device connected to the display device through the input and output port, and
store, in the memory, identification information of a channel of the broadcasting content and identification information of the external device; and
based on receiving a second user input corresponding to a home user interface (UI) button of a remote controller, display a home UI comprising a list of applications providing content, and the identification information of the channel stored in the memory.

2. The display device of claim 1, wherein the identification information of the channel displayed on the home UI comprises an image of the broadcasting content.

3. The display device of claim 1, wherein the input and output port comprises at least one of a high-definition multimedia interface port (HDMI), a component jack, a personal computer (PC) port, and a universal serial bus (USB) port.

4. The display device of claim 1, wherein the one or more instructions, when executed by the at least one processor, further cause the display device to: based on receiving a third user input for selecting the identification information of the channel in the home UI, display, on an entire screen, the broadcasting content of the channel corresponding to the selected identification information of the channel.

5. The display device of claim 1, wherein the external device comprises a set-top box.

6. The display device of claim 2, wherein the plurality of pieces of content correspond to a plurality of channels, and
wherein the one or more instructions, when executed by the at least one processor, further cause the display device to display the image of the broadcasting content from among the list of the plurality of pieces of content corresponding to the plurality of channels with a higher priority than content images corresponding to remaining channels different from the channel of the broadcasting content.

7. The display device of claim 2, wherein the one or more instructions, when executed by the at least one processor, further cause the display device to display, on the image of the broadcasting content, an image or text indicating the broadcasting content output prior to the display of the home UI.

8. The display device of claim 1, further comprising:
communication circuitry,
wherein the home UI further comprises a list of applications for receiving content from a content server through the communication circuitry.

9. The display device of claim 1, wherein the identification information of the channel displayed on the home UI is identification information of the broadcasting content output prior to the display of the home UI.

10. The display device of claim 1, wherein the one or more instructions, when executed by the at least one processor, further cause the display device to:
display, on the display, broadcasting content received through a tuner of the display device, and store identification information of a channel of the broadcasting content received from the tuner and identification information of the tuner, and
based on receiving the second user input corresponding to the home UI button of the remote controller, display a home UI comprising the identification information of the channel of the broadcasting content received through the tuner.

11. A method of providing content, the method comprising:
based on receiving a first user input for changing a channel, displaying, by a display device, broadcasting content received from an external device connected to the display device through an input and output port of the display device and storing identification information of a channel of the broadcasting content and identification information of the external device providing the broadcasting content; and
based on receiving a second user input corresponding to a home user interface (UI) button of a remote controller, displaying a home UI comprising a list of applications providing content, and the stored identification information of the channel.

12. The method of claim 11, wherein the identification information of the channel displayed on the home UI comprises an image of the broadcasting content.

13. The method of claim 11, wherein the input and output port comprises at least one of a high-definition multimedia interface port (HDMI), a component jack, a personal computer (PC) port, and a universal serial bus (USB) port.

14. The method of claim 11, further comprising, based on receiving a third user input for selecting the identification information of the channel displayed on the home UI, displaying, on an entire screen, the broadcasting content of a channel corresponding to the selected channel identification information.

15. The method of claim 11, wherein the external device comprises a set-top box.

16. The method of claim 12, wherein the plurality of pieces of content corresponds to a plurality of channels, and
the displaying of the home UI comprises displaying the image of the broadcasting content from among the list of the plurality of pieces of content corresponding to the plurality of channels with a higher priority than to content images corresponding to remaining channels different from the channel of the broadcasting content.

17. The method of claim 12, further comprising:
displaying, on the image of the broadcasting content, an image or text indicating the broadcasting content output prior to display the home UI.

18. The method of claim 11, wherein the home UI further comprises a list of applications for receiving content from a content server through communication circuitry of the display device.

19. The method of claim 11, wherein the stored identification information of the channel displayed on the home UI comprises identification information of the broadcasting content output prior to displaying the home UI.

20. The method of claim 11, further comprising:
displaying, on the display, broadcasting content received through a tuner of the display device, and storing identification information of a channel of the broadcasting content received from the tuner and identification information of the tuner; and
based on receiving of the second user input corresponding to the home UI button of the remote controller, displaying a home UI comprising the identification information of the channel of the broadcasting content received through the tuner.

21. The display device of claim 1, wherein the identification information of the channel comprises the broadcasting content that is most recently displayed.
